(19) United States
(12) Patent Application Publication
(10) Pub. No.: US 2006/0186992 A1
(43) Pub. Date: Aug. 24, 2006

(54) Device for locking and unlocking the door of a vehicle

(76) Inventors: Uwe Freyholdt, Giengen (DE); Michael Geber, Im Kolzental (DE); Karl-Juergen Peters, Schlehenweg (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/541,727

(22) PCT Filed: Nov. 25, 2003
(86) PCT No.: PCT/EP03/13218

§ 371 Date: Mar. 22, 2006

(30) Foreign Application Priority Data
Jan. 10, 2003 (DE) 103 00 573.0

(51) Int. Cl. B60R 25/00; E05B 65/20

(52) U.S. Cl. 340/5.72; 340/5.62; 307/10.2; 340/426.36

(57) ABSTRACT

A device is provided for locking and unlocking a vehicle door with a door handle which is attached to the outer side thereof. An unlocking sensor arranged in the door-end internal region of the door handle is used for unlocking the vehicle door, which is secured by an electronic access authorization system. An identification sensor is additionally provided in the vicinity of the door handle, and an identification code interrogation by the access authorization system can be started with the identification sensor.

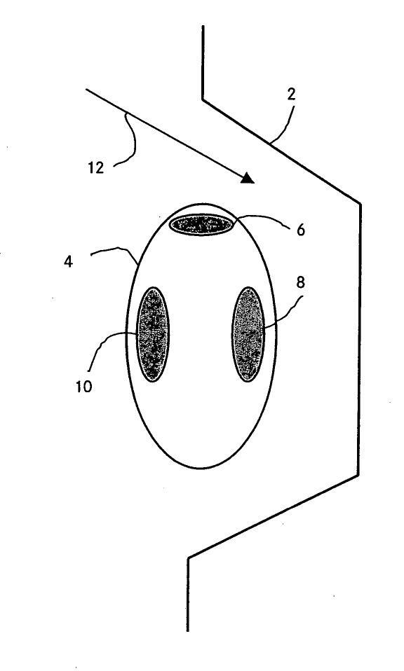

### BACKGROUND AND SUMMARY OF THE INVENTION

The present invention relates to a device for locking and unlocking a vehicle door.

In DaimlerChrysler vehicles, an electronic driving authorization system with the name KEYLESS-GO, which operates without a mechanical key, is used. An identification function is performed by a thin chip card with the format of a conventional EC or credit card. An advantage is that before a car driver gets into the vehicle, he or she does not have to have the key or card in his or her hand; instead the card can always remain in his or her shirt pocket or jacket pocket. The door handles are equipped with contact-sensitive sensors and the lid of the trunk is equipped with a special momentary contact switch. As soon as a driver touches a door handle or activates the momentary contact switch on the rear of the vehicle, his/her chip card receives signals from inductive antennas which are accommodated in the doors and in the rear bumper of the vehicle. In response, the card transmits an identification code to the vehicle by radio. If the code corresponds to the stored value, the owner of the card can immediately get into the vehicle or open the lid of the trunk. The inductive data transfer lasts only for a few fractions of a second.

In order to secure the vehicle after the driver gets out it is sufficient to press a key on the door handle or on the lid of the trunk in order to activate the inductive antennas. The system immediately exchanges data with the chip card again and the data is stored for the later unlocking process, and then secures the car.

German document DE 196 17 038 C2 discloses a lock system and a driving authorization system in which at least one electrode is installed in each of the grip parts of the door handles and in which a counter-electrode, which may also be the door itself, is mounted on the part of the doors lying opposite the grip part. If an electrical field is built up between the two electrodes, the field can be advantageously used to sense even the desire to access the vehicle on the part of a person who is reaching for the door handle. This is done in that a hand which reaches for one of the grip parts located on the doors already brings about a change in the capacitance built up between the two electrodes as it approaches. An electronic system which perceives the change in the capacitance and converts it into a command pulse is contained in a space-saving fashion in the grip part of the door handle. The command pulse which is generated by this electronic system triggers the interrogation of the data carrier in the electronic control unit. The lock system can be locked by a second sensor or momentary contact switch which is mounted on the outside of the grip part. The vehicle is then secured by a person running their hand past in front of the side of the grip part facing away from the vehicle.

Furthermore, German document DE 197 45 149 A1 describes the transmitter/receiver unit for the command pulse to the electronic control unit also being arranged in the region of the door handle.

The invention is then based on the object of specifying a device for locking and unlocking a vehicle door with a door handle which is attached to the outer side thereof and which provides an advantage in terms of time in comparison with the devices known from the prior art, and has improved reliability.

The object is achieved by means of a device for locking and unlocking a vehicle door having the features claimed.

According to the invention, the triggering processes of the person-related identification code interrogation and the unlocking of the door are separated in terms of time and space. At first, the identification code interrogation is brought about when the identification sensor (for example a momentary contact switch or a capacitive proximity sensor) which is easily accessible from the outside responds and the unlocking is then brought about by means of the unlocking sensor (for example a momentary contact switch or a capacity proximity sensor) which can be actuated by gripping behind the door handle. Due to the separation of the functions and the arrangement of the sensors, the actual unlocking process takes place significantly more quickly than in devices which are known from the prior art. In order to ensure that the manual intervention allows the identification sensor to be reached and triggered more quickly, it should be located in an easily accessible region of the door handle, for example in its upper region or its region facing away from the door. By separating the functions of the identification code interrogation and the unlocking process it is also possible for only the identification code interrogation to take place at first and for the unlocking to take place at a significantly later time, which also allows the reliability of the system to be improved.

In one refinement in which the unlocking sensor and the identification sensor are embodied as capacitive sensors, it is advantageous if the capacitive identification sensor is less sensitive than the capacitive unlocking sensor. Unintentional identification code interrogations are thus avoided. These unintentional triggering processes are caused, for example, by weather-related influences such as water or snow on the door handle. Incorrect triggering of the identification sensor is not dangerous since the actual unlocking of the vehicle door only takes place in the second step with the unlocking sensor which is not subject to the weather conditions to the same degree as the identification sensor.

It is advantageous if the identification code interrogation can also be started with the unlocking sensor. As a result, the identification code interrogation can take place redundantly. As a result, the identification code interrogation can still be carried out even if there is a possible failure of the identification sensor.

Further advantageous refinements of the invention are also defined by the claims.

### BRIEF DESCRIPTION OF THE DRAWING FIGURE

The invention is explained in more detail in relation to a plurality of exemplary embodiments in the single figure, with the figure showing a detail from a vehicle door with a door handle mounted on the outside thereof, in a schematic illustration.

### DETAILED DESCRIPTION OF THE INVENTION

The detail of a vehicle which is illustrated in the figure comprises a partially illustrated door 2 and a door handle 4 which is mounted on the outside thereof. The device for locking and unlocking the vehicle door comprises three capacitive sensors 6, 8, 10 which are mounted in the interior of the door handle 4.

The capacitive identification sensor 6 is arranged in the upper internal region of the door handle 4. It serves for starting an identification code interrogation by means of an access authorization system (not illustrated). In one exemplary embodiment (not illustrated in more detail), the door handle 4 is covered by a chrome panel in the region of the capacitive identification sensor 6.

The capacitive unlocking sensor 8 is mounted in the door-side region of the door handle 4 and can therefore be activated only by gripping behind the door handle 4. It is used to unlock the door 2. In addition, a capacitive locking sensor 10 is arranged in the region of the door handle 4 facing away from the door, in order to unlock the door 2. The locking sensor 10 could also be embodied as a momentary contact switch.

During natural manual access, indicated by the arrow 12, by a person with access authorization, in order to open the door 2, said person firstly runs his hand over the upper region of the door handle 4 and arrives at the sensitive region of the capacitive identification sensor 6. The sensor 6 detects the hand and triggers an identification code interrogation in the access authorization system in a known fashion, during which interrogation an inductive transfer of data takes place between the vehicle and a chip card which is carried along by the person with access authorization.

The hand actually arives at the sensitive region of the capacitive unlocking sensor 8 during this identification code interrogation. When the unlocking sensor 8 is triggered, the positive identification code interrogation has already been completed. The vehicle is then unlocked by the triggering of the unlocking sensor 8. Given a negative result of the identification code interrogation the unlocking process is suppressed. The functions of identification code interrogation and unlocking are thus distributed between the two capacitive sensors 6, 8 and, in terms of timing, they occur in succession. Because the identification sensor 6 becomes sensitive at an early time, the entire process from the identification code interrogation to the actual unlocking occurs significantly more quickly than the systems which are known from the prior art and in which the identification interrogation and unlocking are triggered by a single sensor.

The identification sensor 6 can also be arranged on the side of the door handle facing away from the door in order, for example, to be triggered by the ball of the thumb or the thumb of the hand grasping the door handle.

Since the sensors 6, 8, 10 are capacitive sensors in the interior of the door handle 4, every type of expenditure involved in having to protect switches which are located on the door handle against the ingress of dust, dirt and water is dispensed with. The capacitive sensors 6, 8, 10 are cast after installation. The door handle on the outside is thus visually indistinguishable from a door handle without further additional functions.

In conjunction with KEYLESS-GO, an improvement in the locking and unlocking procedure of the individual vehicle doors and of the lid of the trunk is obtained. Operator control is no longer carried out by means of visible switches. The vehicle is unlocked solely by grasping on the door handle 4 when the vehicle is locked. In order to secure the vehicle, that is to say to lock it, the surface of the door handle 4 facing away from the door is merely touched in the sensitive region of the capacitive locking sensor 10 or a hand is run past over it. The vehicle is consequently locked. The operator-friendliness is thus also increased.

In a further exemplary embodiment (not illustrated in more detail), the locking sensor 10 and the identification sensor 6 are functionally combined in a single combination sensor. This is possible because the locking function is never required simultaneously or in direct chronological proximity to the identification function. As a result, the combination sensor can carry out the identification function when the vehicle is locked, and the locking function when the vehicle is opened. The combination sensor may be embodied as a momentary contact switch or as a capacitive sensor.

1-8. (canceled)

9. A device for locking and unlocking a vehicle door comprising:
a door handle which is attached to an outer side of the vehicle door, and
a sensor system, arranged in the door handle, for unlocking the door and starting an identification code interrogation,
wherein the vehicle door is secured via an electronic access authorization system which enables unlocking of the door as a function of a result of the identification code interrogation,
wherein the sensor system has an unlocking sensor for unlocking the vehicle door and an identification sensor for starting the identification code interrogation which are arranged separately from one another on the door handle,
wherein the unlocking sensor is arranged in a door-end internal region of the door handle, and
wherein the identification sensor is arranged in an upper region or in a region of the door handle facing away from the door.

10. The device as claimed in claim 9, wherein the identification sensor is a capacitive sensor.

11. The device as claimed in claim 9, wherein the unlocking sensor is a capacitive sensor.

12. The device as claimed in claim 11, wherein the identification sensor has a lower degree of sensitivity than the unlocking sensor.

13. The device as claimed in claim 9, wherein a locking sensor is provided for locking the door in the region of the door handle facing away from the door.

14. The device as claimed in claim 13, wherein the locking sensor and the identification sensor are functionally combined in a single sensor.

15. The device as claimed in claim 13, wherein the locking sensor is a capacitive sensor.

16. The device as claimed in claim 9, wherein, during the identification code interrogation, an identification code on an external chip card which is carried along by the user is interrogated.

17. The device as claimed in claim 10, wherein a locking sensor is provided for locking the door in the region of the door handle facing away from the door.

18. The device as claimed in claim 17, wherein the locking sensor and the identification sensor are functionally combined in a single sensor.

19. The device as claimed in claim 14, wherein the locking sensor is a capacitive sensor.

20. The device as claimed in claim 17, wherein the locking sensor is a capacitive sensor.

21. The device as claimed in claim 11, wherein a locking sensor is provided for locking the door in the region of the door handle facing away from the door.

22. The device as claimed in claim 21, wherein the locking sensor and the identification sensor are functionally combined in a single sensor.

23. The device as claimed in claim 21, wherein the locking sensor is a capacitive sensor.

24. The device as claimed in claim 12, wherein a locking sensor is provided for locking the door in the region of the door handle facing away from the door.

25. The device as claimed in claim 24, wherein the locking sensor and the identification sensor are functionally combined in a single sensor.

26. The device as claimed in claim 24, wherein the locking sensor is a capacitive sensor.
